(19) United States
(12) Patent Application Publication
(10) Pub. No.: US 2026/0206786 A1
(43) Pub. Date: Jul. 23, 2026

(54) PROCEDURE FOR PREPARING COMPOSITIONS WITH A HIGH CONTENT OF BIOACTIVE COMPOUNDS

(71) Applicant: I.T.P. S.R.L. INNOVATION & TECHNOLOGY PROVIDER, Napoli (IT)

(72) Inventors: Isidoro GARELLA, Cava de' Tirreni (Salerno) (IT); Alessandro NIGRO, Napoli (IT)

(21) Appl. No.: 19/138,513

(22) PCT Filed: Dec. 11, 2023
(86) PCT No.: PCT/IB2023/062493

§ 371 Date: Jun. 12, 2025

(30) Foreign Application Priority Data
Dec. 15, 2022 (IT) 102022000025725

(51) Int. Cl. A23D 9/007; A23L 33/105

(52) U.S. Cl. CPC A23D 9/007; A23L 33/105

(57) ABSTRACT

The present invention relates to a process for the preparation of compositions having a high concentration of bioactive compounds (BACs), as well as to the use of a device for implementing said process, comprising the percolation of halogenated solvents, in particular hydrofluorocarbons and hydrofluoroolefins, through a solid matrix comprising one or more bioactive compounds and the subsequent evaporation of the halogenated solvent in an expansion chamber containing the substance to be enriched. The invention also relates to BAC-enriched compositions thus obtained and to food, cosmetic, nutraceutical, or pharmaceutical products containing them.

### FIELD OF INVENTION

The present invention relates to the field of preparing compositions enriched with bioactive compounds, preferably plant-derived bioactive compounds. More particularly, the invention relates to a process for the preparation of lipid compositions with a high concentration of fat-soluble bioactive compounds, the lipid-enriched compositions thus obtained and products containing them.

### BACKGROUND

Lipid substances enriched with bioactive compounds, known as oleolites, are widely used in pharmaceuticals, food and cosmetics; oil is in fact the best solvent for fat-soluble bioactive compounds contained mainly in plant matrices.

Conventionally, to prepare oleolites, pure bioactive compounds or a concentrate of such compounds, e.g. an oleoresin, are dissolved in the matrix to be enriched by simple manual or mechanical mixing, e.g. by mechanical or magnetic stirrers, often while hot to increase the solubility of the bioactive compound in the matrix. This represents a disadvantage since most bioactive compounds, especially those of plant origin, are thermolabile and therefore suffer from high process temperatures. The preparation of oleolites by dissolution has as its main and further disadvantage the need to obtain these bioactive compounds, in their pure state, through a preliminary extraction process and subsequent purification.

Alternatively, one can proceed by extraction of the bioactive compounds contained in a plant matrix through a process of maceration of the latter in a substance of a lipidic nature in a liquid state, usually a vegetable oil, again possibly increasing the temperature to facilitate the dissolution of the compound in the matrix. However, maceration involves relatively long processing times.

In any case, matrices enriched using conventional techniques have relatively low concentrations of the bioactive compound and therefore require frequent administration or massive dosing of the end product to achieve the desired effects.

The concentration of a bioactive compound in a lipid substance, at a given temperature, depends on both the chemical nature of the compound and the type of lipid substance used as a solvent. By way of example, the following are some data, found in the literature, referring to the maximum concentrations obtainable in lipid matrices of three bioactive compounds, the oleolites of which are widely used in nutraceutical and cosmetic applications: lycopene, a potent antioxidant belonging to the carotenoid family and found mainly in tomatoes; curcumin, belonging to the curcuminoid family and extracted from the root of Curcuma longa; and capsaicin, an alkaloid found in plants of the genus Capsicum (e.g. hot pepper). The maximum concentration of lycopene in vegetable oil that can be obtained using the traditional preparation techniques outlined above is approximately 7-8 mg per 100 g of oil; the highest reported concentration of curcumin in vegetable oil is approximately 50 mg per 100 g of oil; the concentration of capsaicin in vegetable oil is no more than 10 mg per 100 g of oil.

The technical problems outlined above have not been effectively solved to date, and there is therefore still a need for an efficient procedure for the preparation of compositions with a high content (concentration) of bioactive compounds or active ingredients, which is simple to implement, effective in guaranteeing the desired concentrations, and at the same time industrially scalable. Ideally, the procedure should also make it possible to control the concentration of the compound in the composition to be prepared.

Advantageously, as further illustrated below, the process of the present invention overcomes the drawbacks of known methods, and also allows the content of bioactive compound in the substance to be enriched to be controlled during the extraction and/or enrichment process.

### GLOSSARY

Unless otherwise indicated, terms used in the context of this description are to be interpreted as commonly understood by a person skilled in the technical field relevant to the invention.

In the context of the present description, the term “bioactive compound (BAC)” or more generally the term “compound” means any substance or combination of substances having a biological/chemical/physical action that is beneficial to human or animal health, e.g., a substance or combination of substances suitable for the prevention and/or treatment of certain diseases, useful for alleviating or eliminating one or more symptoms, but also a substance or combination of substances having a nutritive or physiological (e.g., vitamins and minerals) or cosmetic action. The term ‘compound’ in the context of this description is interchangeable with the term ‘active ingredient’. With reference to compounds of plant origin, the term ‘compound’ may also refer to the association of substances better known as a ‘phytocomplex’, i.e. the totality of the chemical components of a plant, resulting from the natural combination of the active ingredient with other substances, therapeutically inactive or with activities of a different nature, but which together give the plant the specific therapeutic properties for which it is used.

In the context of this description, the term “oleolites” refers to oily solutions of healing phytocomplexes of medicinal plants, flavoured seasoning oils or related products.

In the context of the present description, the wording “comprising” certain features means that the process/device/composition/product of the invention includes those features, but that the presence of other features is not excluded, whereas the wording “consisting of” certain features means that no other features are present in the process/device/composition/product than those following the wording. In the context of the present description, however, the term “comprising” may also be used to mean “consisting of”.

### SUMMARY OF THE INVENTION

The main purpose of the present invention is therefore to provide a process for the preparation of compositions, in particular lipid compositions or oleolites, having a high content of bioactive compounds or active ingredients, which makes it possible to overcome the problems outlined above. A further purpose of the present invention is to provide a process of the type mentioned above, which allows the active ingredient content of the lipid substance/composition to be enriched to be controlled during the process itself, while at the same time realising a significant reduction in process costs compared to known systems, especially in terms of energy consumption.

These purposes are achieved by the extraction and concomitant enrichment process according to claim 1 appended hereto or by a process for the preparation of a composition containing one or more bioactive compounds comprising the following steps (which may be repeated as many times as necessary to obtain the desired concentration, preferably the maximum concentration, of bioactive compound in the chosen matrix):
percolating a halogenated solvent in the liquid phase through a solid material, preferably a solid material of plant origin, containing at least one bioactive compound, or through a pure bioactive compound, under conditions of temperature and corresponding condensation pressure of the halogenated solvent, thereby obtaining a solution of the bioactive compound in the halogenated solvent,
introducing said solution (i.e. the halogenated solvent in which the bioactive compound has dissolved) into an expansion chamber equipped with suction means, at a pressure corresponding to the evaporation pressure of the halogenated solvent; and
suctioning the halogenated solvent in vapour phase away from the expansion chamber by means of such suction media (e.g. a compressor 4);
the process being characterised by the fact that said expansion chamber is pre-charged with a substance, preferably a lipid substance, such that when the solvent is aspirated, the at least one bioactive compound (the solute) in the solution is released into the lipid substance.
   Advantageously, the process further comprise the phase of:
recondensing the aspirated halogenated solvent, using a suitable heat exchanger, regenerating it, in order to reiterate, as many times as necessary, the steps described above, and thus obtain a composition with a high concentration of said bioactive compound or, in any case, a desired concentration.

As better explained below, the process of the invention is further advantageously characterised by the fact that, after each release step of the bioactive compounds into the lipid substance pre-loaded in the expansion chamber, the concentration of the bioactive compounds is continuously homogenised by the tumultuous evaporation of the halogenated solvent, such as to avoid areas of local over-concentration resulting in the precipitation of said bioactive compounds.

Compositions having a high content of bioactive compounds obtainable by the process according to any of the embodiments of the invention have a concentration of bioactive compound(s) up to two orders of magnitude higher than what can be obtained by applying the methods known in the art. In other words, the process according to any one of the embodiment of the present invention allows to increase the effective solubility of the compound in the matrix to be enriched, for example vegetable oil or synthetic oil.

Consequently, the process of the invention also makes it possible to decrease the posology and/or dosage of the composition, and thus increase patient compliance, while achieving the same benefits in terms of efficacy.

Thus, a further object of the invention is a composition comprising a substance, preferably a lipid substance, enriched with at least one bioactive compound obtained or obtainable by the above-mentioned process. Further objects of the invention are the use of the aforementioned composition in the preparation of a food, cosmetic, pharmaceutical and/or nutraceutical product and the food, cosmetic, pharmaceutical and/or nutraceutical product comprising it, the essential characteristics of which are defined in the respective independent claims appended hereto.

Still a further object of the invention is the use of the device better described below—or according to any of the embodiment already described in Italian patent No. 102009901793170 referred to herein in its entirety by reference—for the preparation of compositions, in particular lipid compositions, both solid and liquid, enriched in bioactive compounds.

Other features and advantages of the process according to the invention will become clearer from the following description of one of its embodiments, described by way of example and not limitation, also with reference to the accompanying drawings and examples.

### BRIEF DESCRIPTION OF DRAWINGS

FIG. 1 represents a functional plant scheme of an embodiment of the device according to the invention.

FIG. 2 shows the HPLC chromatogram of lycopene-enriched Argan oil obtained according to Example 1 (solid line), superimposed on the chromatogram of Argan oil enriched by maceration of pure lycopene powder in oil (dashed line).

FIG. 3 shows the superimposed UV/VIS spectra of oils enriched according to Example 1 (solid line) and by maceration of pure lycopene powder in oil (dashed line).

FIG. 4 shows the HPLC chromatogram of wheat germ oil enriched with curcuminoids from Curcuma longa root according to Example 2 (solid line), superimposed on the chromatogram of wheat germ oil enriched by maceration of Curcuma longa powder in oil (dashed line).

FIG. 5 shows the superimposed UV/VIS spectra of oils enriched according to Example 2 (solid line) and by maceration of Curcuma longa powder in oil in comparison (dashed line).

FIG. 6 shows the superimposed UV/VIS spectra of sunflower oils enriched with capsaicin by the procedure described in Example 3 (solid line) and by maceration (dashed line).

FIG. 7 is a histogram showing the concentration values of various bioactive compounds (lycopene, curcuminoids, capsaicin) in oils enriched according to the process of the invention (Examples 1, 2 and 3) compared to the concentration values obtainable by known techniques (maceration).

### DETAILED DESCRIPTION OF THE INVENTION

The inventors of the present invention, after extensive experimentation, have discovered that an extraction device such as that disclosed in Italian patent No. 102009901793170 can also be advantageously used for the preparation of compositions with a high content of bioactive compounds, in particular oleolites.

More specifically, starting from the intuition that by introducing a substance into the solvent expansion chamber of the extraction device described therein, the substance itself could be enriched with the extracted compound, the inventors developed a procedure for the enrichment of substances, in particular lipid substances, with compounds of interest, in particular lipophilic bioactive compounds. Surprisingly, the procedure was able to overcome the drawbacks of the enrichment systems/methods already known in the technique, in particular allowing the solubility of the compounds of interest in the selected lipid substance to be substantially increased.

Therefore, the present invention relates to a process for the preparation of a composition containing one or more bioactive compounds comprising the following steps:
percolating a halogenated solvent in the liquid phase through a solid material, preferably a solid material of plant origin, containing at least one bioactive compound, or through a pure bioactive compound, at the temperature and corresponding condensation pressure of said halogenated solvent, thereby obtaining a solution of the bioactive compound in the halogenated solvent,
placing or collecting said solution (i.e. the halogenated solvent in which the bioactive compound has dissolved) in an expansion chamber equipped with suction means (e.g. compressor) at the temperature and corresponding evaporation pressure of the halogenated solvent; and
suctioning the halogenated solvent in the vapour phase away from the expansion chamber;
the process being characterised by the fact that this expansion chamber is pre-charged with a substance, preferably a lipid substance, such that when the solvent is aspirated, at least one bioactive compound (the solute) is released into the lipid substance.
   The halogenated solvent may be a halogenated solvent having a condensation pressure room temperature of approximately 10 atm or less. Preferably, the halogenated solvent is chosen from halogenated hydrocarbons, halogenated hydroolefins and mixtures thereof. Suitable halogenated hydrocarbons are, for example, hydrofluorocarbons (HFCs), while suitable halogenated hydroolefins are, for example, hydrofluoroolefins (HFOs).

Among hydrofluorocarbons (HFCs), 1,1,1,2-Tetrafluoroethane (R134a) is particularly suitable.

Among the hydrofluoroolefins (HFOs), 2,3,3,3terafluoroprop-1 -ene (HFO-1234yf) (1E)-1,3,3,3-tetrafluoroprop-1-ene (HFO-1234ze) are particularly suitable, as they have the advantage of being non-flammable, non-toxic and not harmful by inhalation and ingestion, and at the same time not damaging to the ozone layer in the atmosphere and having a low potential on Global Warming.

Halogenated solvents such as HFCs or HFOs, although gaseous at room temperature and pressure, can be easily liquefied at low pressures so that they can be used in the liquid state in the first extraction step through the solid material comprising the compound of interest, but then easily removed by evaporation from the extract or the final lipid composition, simply by restoring the ambient temperature and pressure conditions.

Advantageously, the process according to any of the embodiments of the invention may comprise a further step of regenerating the solvent(s) used, which comprises recondensing the solvent(s) for reuse in one or more further percolation cycles through said solid material. The regeneration step—and thus compression and/or re-condensation—of the halogenated solvent(s) used may take place according to conventional techniques or also by means of the system better described below.

The advantage represented by the heat exchanger downstream of the compressor, which allows the recovery and reuse of the solvent used, is also combined with a relatively low volume use of solvents in relation to the mass of solid material to be treated, so that production costs are effectively controlled, moreover, the process is carried out in a shorter time than the main techniques currently used.

Therefore, the process of the invention can advantageously comprise a further step of:
re-condensing the aspirated halogenated fluid, e.g. by using a suitable heat exchanger, and percolate it again, in the liquid phase, fully regenerated, through the solid material to repeat the above steps as many times as necessary.
   In other words, according to a preferred embodiment, the present invention relates to a process for the preparation of a composition containing one or more bioactive compounds comprising the following steps:
percolating a halogenated solvent through a solid material containing at least one bioactive compound in a pressure-tight chamber under conditions of temperature and pressure corresponding to that of condensation of said halogenated solvent;
collecting the percolated halogenated solvent in an expansion chamber equipped with suction means under conditions of evaporation temperature and pressure of said halogenated solvent such that the solvent passes into a vapour phase; and
aspirating the halogenated solvent in the vapour phase away from the expansion chamber,
the process being characterised by the fact that said expansion chamber is pre-loaded with a lipid substance such that, when the solvent is aspirated, at least one bioactive compound is released into the lipid substance to give a composition comprising said bioactive compound,
this process further comprising a re-condensation step of the aspirated halogenated solvent for reuse in one or more further percolation cycles through said solid material.

In principle, the process according to any of the embodiments of the invention can be used to enrich any matrix or substance, whether solid, semi-solid or liquid, with a generic compound of interest. However, the process is particularly efficient in the enrichment of lipid substances, matrices or compositions in the liquid state with lipophilic bioactive compounds.

In particular, the process has been shown to be effective for the enrichment of lipid substances of vegetable, mineral, synthetic or semi-synthetic origin, preferably an oil, butter, wax or mixtures thereof. By way of example, but in no way limiting, this oil is chosen from sunflower oil, coconut oil, argan oil, wheat germ oil, soybean oil, vaseline oil and mixtures thereof.

Any solid material containing at least one bioactive compound or active ingredient can be used as a starting material. The following are, for example, suitable: a plant biomass, a plant drug (leaves, inflorescences, roots, etc.), a pure (bioactive) compound, a concentrated oleoresin, or even liquid mixtures containing one or more bioactive compounds suitably immobilised on an inert solid support.

When the halogenated solvent is placed in contact, e.g. percolated, on the solid material containing the bioactive compound(s), the compound dissolves in the solvent, generating a dilute solution of said bioactive compound(s), by virtue of the latter's much lower solubility than that exhibited by conventional organic solvents, and is then transported to the evaporation chamber where the solvent evaporates while the at least one bioactive compound dissolves in the substance to be enriched suitably pre-charged in the evaporation chamber.

The compound, as mentioned above, may be a generic compound contained in the solid starting material being treated but, preferably, is a lipophilic and/or soluble bioactive compound in the halogenated solvent employed. By way of example, but in no way limiting, the compound is a bioactive compound of plant origin, preferably chosen from carotenoids (e.g., lycopene), alkaloids (e.g., capsaicin), curcuminoids (e.g., curcumin), cannabinoids (e.g., CBD, THC) or mixtures thereof.

The present invention, further relates to a composition obtainable by the process according to any of the embodiments described herein, comprising a lipid substance and at least one bioactive compound in a higher concentration than that obtainable by the conventional enrichment methods previously mentioned. In a preferred embodiment, said composition comprises argan oil enriched with lycopene, in particular having a lycopene concentration equal or above 30-35 mg per 100 g of composition. In a further preferred embodiment, said composition comprises wheat germ oil enriched with curcumin, in particular having a curcumin concentration equal or above 1420 mg per 100 g of composition. According to another embodiment, said composition comprises sunflower oil enriched with capsaicin, in particular having a capsaicin concentration equal or above 61.2 mg per 100 g of composition.

As will be readily apparent to a person skilled in the art, compositions having a high content of bioactive compounds or active ingredients obtained or obtainable by the process according to any of the embodiments described herein may be used per se, for example, for use as a medicament, cosmetic, nutraceutical product, food supplement, etc., depending on the compound contained therein, but are obviously also suitable for inclusion in other preparations. The present invention therefore also relates to a food, cosmetic, pharmaceutical and/or nutraceutical product comprising the composition according to any of the embodiments described herein.

As mentioned above, the process of the present invention may take place in a device according to any of the embodiment described in Italian patent No. 102009901793170.

It is understood, however, that even constructively simpler devices are suitable for the purpose. In fact, in order for the process of the invention, at least in its simplest embodiment, to take place, the device must be provided with at least a first pressure-tight container suitable for (or configured to) accommodate the solid material to be treated and provided with solvent inlet means positioned in such a way that the solvent inlet intercepts the solid material, said first container being in fluid communication with a second container in which to carry out the evaporation of the solvent, and provided with suction means for removing the solvent and, possibly, condensation means for returning the solvent, regenerated, from the vapour phase to the liquid phase to allow the treatment to be repeated.

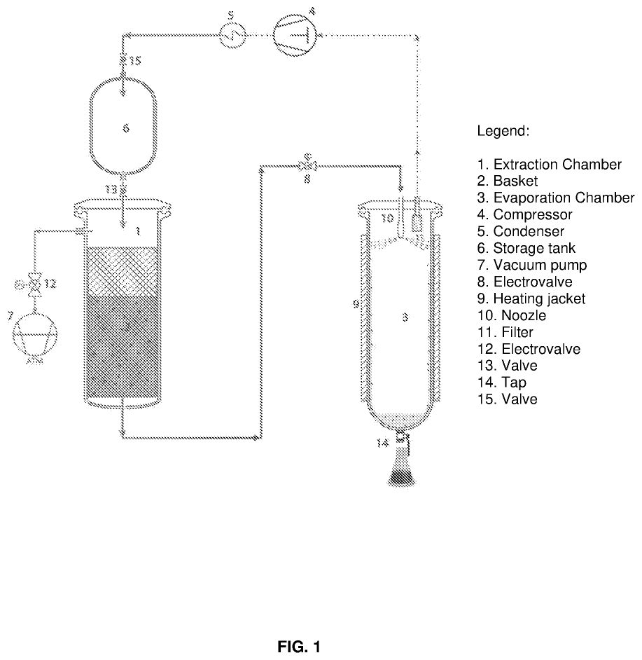

More specifically, a device suitable for implementing the procedure described here, with reference to FIG. 1, comprises:
a pressure-tight first chamber 1 housing a solid material containing at least one bioactive compound or one pure bioactive compound, said first chamber being provided with feeding media for a halogenated solvent positioned so that the incoming solvent intercepts the solid material, said first chamber being in fluid communication with
a second evaporation chamber 3 equipped with suction means to remove the solvent in the vapour phase and suitable for housing or containing at least the substance (e.g. lipidic, as defined above) to be enriched with the bioactive compound.

As described in more detail below, said first chamber 1, henceforth also the extraction chamber, may be of cylindrical design and equipped with a removable basket 2 for containing said solid material to be treated.

The chamber 1 can be equipped with heating means such as a heating cartridge placed inside the chamber 1 in its lower part, or an external heating band, to set the optimal temperature and, indirectly, pressure values to optimise the yield of the extraction process. The chamber can be equipped with a pressure gauge for pressure control and associated with a pump (e.g. a vacuum pump) for the elimination of non-condensable gases whose presence would impair the extraction process.

The first chamber 1 is in fluid communication with the second chamber 3 via a conduit possibly equipped with at least one valve (solenoid valve 8) to control the amount of solution fed.

Said second chamber 3, or evaporation chamber, of the device comprises means for dispensing the solution 10 from said first chamber 1, preferably suitable for distributing the solution over an inner surface of said evaporation chamber. Suitable delivery means comprise, for example, at least one nozzle or atomiser.

Under suction of the suction media (e.g., compressor 4) and in the presence of oil (or other lipidic substance) inside the evaporation chamber 3, oily clouds consisting of microparticles of oil are generated, which tend to be deposited along the walls of the chamber. The refrigerant fluid introduced into the chamber through nozzle 10 is made to percolate along the walls of the chamber and, as it evaporates, releases the bioactive compounds that solubilise in the oil deposited along the walls of the chamber; in this way it is possible to obtain a uniform distribution of the bioactive compound within the oil, avoiding the creation of areas of excessively high concentration that would precipitate the compound. Due to the release of the solution, containing the refrigerant fluid, along the walls and the continuous generation of the oily clouds by the suction of the compressor, the oily layer deposited on the walls of the chamber is continually renewed and the concentration of the active ingredient is homogenised within the total mass of oil present in it.

The chamber 3 can be associated with a transducer which acts as a probe for continuous pressure monitoring, providing a control signal to a management unit (e.g. a PLC programmable logic controller or a microprocessor unit) capable of controlling, in response to said signal, the opening of the solenoid valve 8, thereby automating the introduction of the appropriate amount of solution into the expansion chamber 3.

The second evaporation chamber 3 is connected to a vapour phase solvent recovery and regeneration system exiting said second chamber comprising, compression media 4 and recondensation media 5 as generally known to a person skilled in the field.

The solvent supply means to said first chamber 1 may also comprise a solvent storage or accumulation tank 6 in fluid communication with said recondensation means 5 and preferably wherein said solvent recondensation means 5 comprise means for diverting the recondensed solvent to said storage tank 6.

More in detail, at the outlet of the evaporation chamber 3, downstream of a filter drier 11, and along a vapour delivery line, there is a compressor 4 and condenser 5 system with associated pressure transducer and one-way valve. The vapour delivery line, downstream of the condenser 5, returns to a liquid delivery line and leads to the inlet of the extraction chamber 1, if provided via the solvent storage tank 6.

Therefore, this process exploits the change of state from liquid to vapour and vice versa of the halogenated solvents, with a dual purpose: firstly, it exploits evaporation to easily and abruptly remove the extraction solvent (or more generally the solvent used to treat the solid material) from the composition to be prepared, then it exploits condensation to liquefy and then recirculate and reuse the solvent for subsequent cycles of the process. Among other things, it should be pointed out that the process involves the use of small quantities of halogenated solvents, quantities comparable in volume to the solid material to be treated, which are in any case continuously regenerated during the process in such a way as to also present the maximum extractive power whenever they are percolated through the solid material from which the bioactive compound of interest is to be extracted. Considering the poor solubility in halogenated hydrocarbons of many substances subjected to the extraction and/or enrichment process of the present invention, the possibility of using a quantity of solvent comparable in volume to the solid matrix mass, regenerating it continuously and in a relatively short time, represents a fundamental advantage of the process of the invention.

In addition, the process according to any of the embodiments of the invention can be conducted at room or sub-ambient temperature, which further reduces production costs and simplifies the plant.

Another advantageous aspect is related to the use of an extraction chamber 1, separate from the evaporation/enrichment chamber 3, so as to move the extract away from the extraction chamber 1 and thus preserve its properties in case the extraction is conducted at higher temperature values than room temperature (generally, however, not exceeding 50° C.) for example to speed up the extraction process and optimise the extraction yield. The presence of a heating medium possibly placed in the lower part of the extraction chamber allows the desired temperature values to be reached, thus impregnating the solid matrix with solvent and consequently allowing the extraction phase to be conducted at the desired temperature.

Thus, the present invention also relates to the use of the device as described herein, or according to any of the forms of embodiment described in Italian patent No. 102009901793170, for the preparation of compositions, in particular lipid compositions, with a high content of bioactive compounds.

It is understood that the device described herein may also be modified with one or more of the technical features described in relation to the device in Italian patent No. 102009901793170. In other words, the components of the device described herein can be combined with one or more components of the device according to any of the embodiments described in Italian patent No. 102009901793170, unless there is some technical incompatibility.

Although it has been made clear that the process of the invention can be carried out in a constructively simpler device, that of the Italian patent No. 102009901793170 is particularly suitable for the purpose and, therefore, using the device described there, a number of processes of enrichment of appropriate vegetable oils with active ingredients extracted from vegetable matrices, extraction and enrichment performed simultaneously (Examples 1-3), have been carried out as examples.

In any case, the solid material or solid matrix to be treated is placed inside the basket 2 housed in the extraction chamber 1. After eventually eliminating all the incondensable gases within the entire system by means of the vacuum pump, an appropriate quantity of solvent, initially housed in the storage tank 6 and maintained under pressure in the liquid state, is made to flow, for example by means of the opening of a manual valve, inside the extraction chamber 1 in such a way as to intercept the solid material to be treated. Following the timed opening of the solenoid valve 8, a suitable quantity of solvent is injected into the evaporation chamber 3 and, through at least one atomiser or nozzle 10, sprayed and made to flow along the inner walls of the evaporation chamber 3. In this phase, the solvent evaporates and is sucked by means of suitable suction means (compressor 4), through a duct, and re-condensed by means of a heat exchanger (condenser 5) from which the re-condensed and regenerated solvent is returned in liquid form to the extraction chamber 1 through a duct, possibly provided with a valve 13, connecting the bottom of the tank 6 with the apex of the extraction chamber 1.

The regenerated solvent thus comes back into contact with the solid matrix, percolating through it and re-saturating the extractable bioactive compounds, and then returning to the evaporation chamber 3 and releasing the extracted bioactive compounds into the lipidic substance preloaded in the evaporation chamber 3. The cycle just described is repeated as many times as necessary to render the plant matrix exhausted, i.e. until the lipidic substance is saturated with bioactive compound and the composition thus obtained recovered from the bottom of the evaporation chamber 3 where it is deposited, by accessing it, for example, from above after removing the closing cap or by opening the tap 14 (as shown in FIG. 1) to tap the composition from the bottom of the chamber 3, the exit being facilitated by the presence of a residual pressure that can be maintained for the purpose in the expansion chamber. The exhausted solid matrix, deprived of both the extracted principles and the solvent used during extraction, is removed from the basket 10 of the extraction chamber 1 to be replaced with a virgin matrix in view of a new extraction process. Cycle after cycle, the active ingredients or extracted compounds, solubilised by the solvent, are released into the evaporation chamber 3 (and thus into the lipid substance to be enriched with the bioactive compound previously pre-loaded in the expansion vessel), upon evaporation of the solvent, which will thus be regenerated and with maximum extraction power, a power that remains unchanged during each extraction cycle.

As mentioned, the operation of the device can be automated through the use of a PLC or equivalent, the implementation and configuration of which will be obvious to a person skilled in the art on the basis of the functional and control requirements highlighted above. Even the overall circuit arrangement of the device, beyond the outline scheme described and illustrated here or in the Italian patent already mentioned, may be subject to constructive variants according to what is obvious in the context of the knowledge acquired in the plant engineering of this type of devices. When speaking of percolation cycles, it is obviously not intended that the process must necessarily be discontinuous. On the contrary, with the appropriate controls, the process can be managed in such a way that it is almost continuous.

Below are some examples of illustrative, and not limiting, embodiment of the process of the invention.

### EXAMPLES

### Materials and Methods

Spectrophotometric analyses were performed using an ONDA UV/VIS Spectrophotometer, Model UV-31 SCAN. The oil samples were suitably diluted in RPE ethanol supplied by Carlo Erba. Scans were performed in the wavelength range of 600 nm and 300 nm, with a step size of 1 nm, using optical glass cuvettes.

HPLC analyses were performed using an Agilent HPLC Chromatograph, 1100 Series, equipped with an Agilent Technologies 1200 Series DAD UV/VIS detector, using an Agilent Eclipse plus 95 Å C18 Column, (100 mm—4.6 mm, 3.5 μm). Acetonitrile, Methanol, Water and Formic Acid for HPLC supplied by Sigma-Aldrich were used for the mobile phase.

### Example 1: Process of Enriching Argan Oil With Lycopene From Tomato Paste

8.0 g of food-grade tomato paste with a lycopene content of 4.8 mg (previously determined by extraction with a Soxhlet apparatus using n-hexane as eluent) was mixed with 32.0 g of flaked wheat germ and placed inside the extraction chamber (1). This mixing was necessary to optimise solvent percolation through the matrix.

5.0 mL of refined argan oil was added to the evaporation chamber (3). An isomer of 1,3,3-Tetrafluoropropene, belonging to the class of hydrofluoroolefins (HFO), and commercially identified by the initials R1234ze, was used as the extracting solvent.

The process was conducted at a temperature of 28° C. corresponding to a pressure of 4.5 atm for a time of 120 minutes.

At the end of the process, 5 mL of enriched oil was recovered with a concentration expressed as mass of lycopene per mass of oil of 35 mg/100 g, a concentration measured at 25° C. after centrifuging the oil for 15 minutes at 10,000 RPM.

At the end of the process, the tomato paste matrix used is evidently faded and thus depleted of lycopene, whereas the Argan oil enriched by the procedure of Example 1 is characterised by an intense red colouration imparted by the lycopene dissolved in it.

Example 2: Process for Enriching Wheat Germ Oil With Curcumin From Curcuma longa Root Powder

4.378 g of Curcuma longa root powder for food use with a curcuminoid content of 289.0 mg/g (previously determined by extraction with a Soxhlet apparatus using ethanol as an eluent) was mixed with 45.0 g of flaked wheat germ and placed inside the extraction chamber (1). This mixing was necessary to optimise solvent percolation through the matrix.

5.0 mL of wheat germ oil was added to the evaporation chamber (3). An isomer of 1,3,3-Tetrafluoropropene, belonging to the class of hydrofluoroolefins (HFO), and commercially identified by the initials R1234ze, was used as the extracting solvent.

The process was conducted at a temperature of 28° C. corresponding to a pressure of 4.5 atm for a time of 355 minutes.

At the end of the process, 5 mL of enriched oil was recovered with a concentration expressed as mass of Curcumin on mass of oil of 1420 mg/100 g, a concentration measured at 25° C. after centrifugation of the oil performed for 15 minutes at 10,000 RPM.

The matrix consisting of the mixture of Turmeric longa root powder and Wheat Germ flakes after the extraction/enrichment process of Example 2, is evidently discoloured and thus depleted of curcuminoids, while the enriched Wheat Germ oil is characterised by an intense yellow/orange colouration imparted by the dissolved curcuminoids. In addition, TLC (Thin Layer Chromatography) analysis comparing Turmeric extract obtained by Soxhlet extraction and wheat germ oil after enrichment with curcumin according to Example 3 showed a selectivity of curcumin in the extraction step, which occurs at the same time as the enrichment step, over the other two curcuminoids (Demethoxycurcumin and Bisdemethoxycurcumin) present in Curcuma longa root powder.

### Example 3: Sunflower Oil Enrichment Process With Capsaicin From Calabrian Hot Pepper Powder (Diavolicchio)

10.0 g of food-grade Calabrian hot chilli peppers with a capsaicin content of 2.10 mg/g dry matrix (previously determined by extraction with a Soxhlet apparatus using ethanol as an eluent) were placed inside the extraction chamber (1).

In the evaporation chamber (3), 5.0 mL of deodorised sunflower oil was added. An isomer of 1,1,1,2-Tetrafluoethane, belonging to the class of hydrofluorocarbons (HFCs), and commercially identified by the abbreviation R134a, was used as the extracting solvent.

The process was conducted at a temperature of 35° C. corresponding to a pressure of 7.66 atm for a time of 90 minutes.

At the end of the process, 5 mL of enriched oil was recovered with a concentration expressed as mass of Capsaicin on mass of oil of 61.2 mg/100 g, a concentration measured at 25° C. after centrifugation of the oil performed for 15 minutes at 10,000 RPM.

Sunflower oil enriched using the Example 3 process is characterised by an intense red colouration imparted by the capsaicin dissolved in it.

### Example 4: Comparative

For the purposes of comparison, as mentioned above (State of the Art) the maximum concentration that can be obtained by traditional lycopene preparation techniques in vegetable oil is about 7-8 mg per 100 g of oil (see, for example, N. M. Sachindra, N. S. Mahendrakar/Bioresource Technology 96 (2005 ) 1195-1200 and Dalia Mieliauskaitė et al, Lycopene Solubility and Its Extraction from Tomatoes and Their By-products, *Lithuanian Institute of Horticulture, Biochemistry and Technology Laboratory, Written for presentation at the 2009 CIGR Section VI International Symposium on Food Processing, Monitoring Technology In Bioprocesses And Food Quality Management, Germany 31 Aug.-2 Sep. 2009); the highest reported concentration of curcumin in vegetable oil is about 50 mg per 100 g of oil (Makiko Takenaka1*, et al., Food Sci. Technol. Res., 19 (4 ), 655-659, 2013); the concentration of capsicin in vegetable oil does not exceed 10 mg per 100 g of oil (Asian J Pharm Clin Res, Vol 7, Suppl 1, 2014, 48-51).

### Example 5: Comparative

In order to compare the efficacy of the method of the invention with the traditional method of enrichment by maceration in oil, enrichment of vegetable oils was carried out using both methods. Subsequently, equal amounts of oil obtained using the two methods were solubilised in a suitable solvent, respecting the same dilution ratio, and the resulting solutions were subjected to chromatographic and spectrophotometric analysis.

### Lycopene

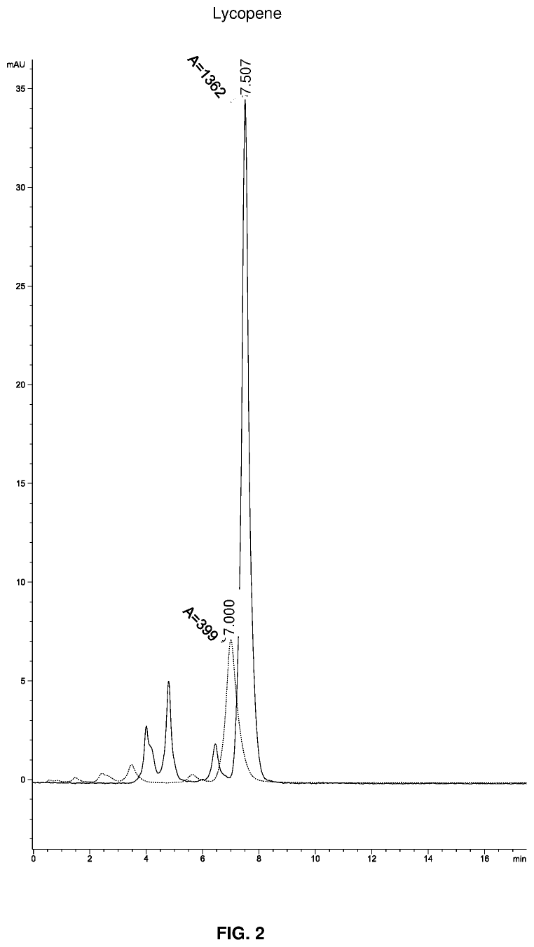

FIG. 2 shows the HPLC chromatogram of Argan oil enriched with lycopene obtained according to Example 1 (solid line), superimposed on the chromatogram of Argan oil enriched using traditional methodology (dashed line, maceration of pure lycopene powder in oil).

As is apparent from the chromatograms, the area subtended by the peak at retention time 7,507 (A=1362), proportional to the concentration of lycopene present in the oil enriched by the process of the invention, is about 3.3 times greater than the area subtended by the peak at retention time 7,000 (A=399), proportional to the concentration of lycopene present in the oil enriched by the conventional method.

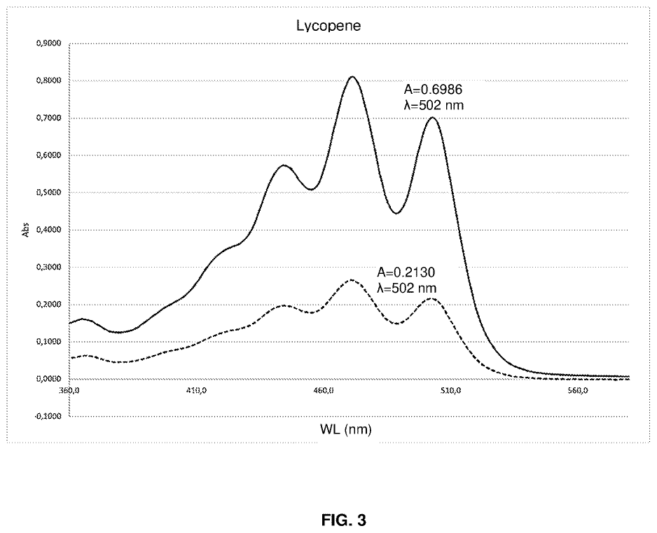

FIG. 3 shows the superimposed UV/VIS spectra of the oils enriched with the two methods in comparison. This analysis also shows that the concentration of lycopene present in the oil enriched according to the procedure of the invention, a concentration proportional to the absorbance measured at 502 nm (A=0.6986), is approximately 3.3 times higher than the concentration of lycopene present in the oil enriched using the traditional methodology (A=0.2134).

### Curcumin

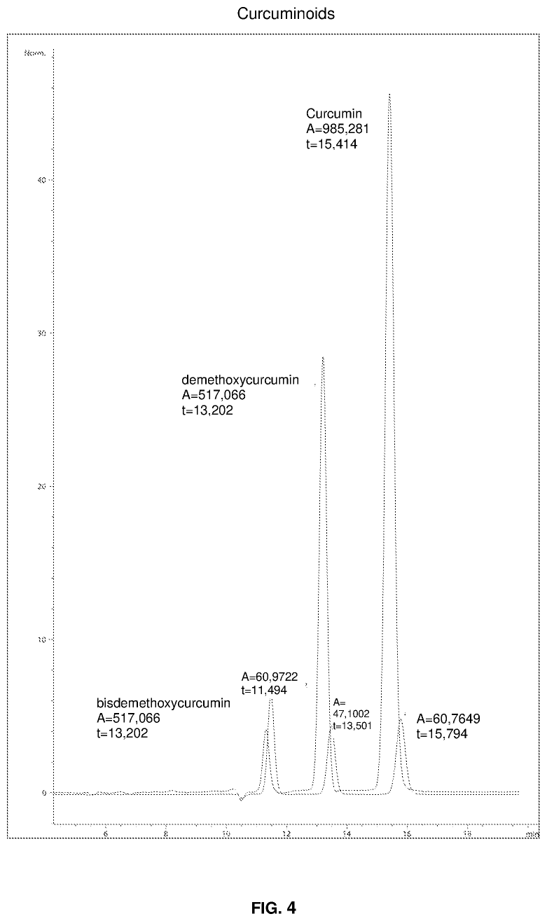

FIG. 4 shows the HPLC chromatogram of wheat germ oil enriched with the three main curcuminoids present in Curcuma longa root powder (Bisdemethoxycurcumin, Demethoxycurcumin and Curcumin) according to Example 2 (solid line), superimposed on the chromatogram of wheat germ oil enriched using traditional methodology (Maceration of Curcuma longa powder in oil, dashed chromatogram).

As is evident from the chromatograms, the sum of the areas subtended by the peaks at the retention times of 11.314, 13.202 and 15.414 (_{Atotal}=1540.8) respectively, areas proportional to the concentration of the respective curcuminoids present in the oil enriched by the process of the invention, is about. 9 times greater than the sum of the areas subtended by the peaks at the retention times of 11.494, 13.501 and 15.794 respectively (_{Atotal}=168.8), areas proportional to the concentration of the respective curcuminoids present in the oil enriched by the conventional method.

Furthermore, a very interesting aspect emerges from the HPLC analysis, namely that the oil enrichment carried out by means of the process of the invention turns out to be clearly more selective with regard to Curcuma, the curcuminoid of greatest interest for its properties, than the other two curcuminoids (Demethoxycurcumin and Bisdemethoxycurcumin). The experimental data obtained show that the percentage of Curcumin present in the oil enriched using the innovative methodology is 62.2%. In contrast, the percentage of Curcumin present in the oil enriched using the traditional methodology is 36.0%.

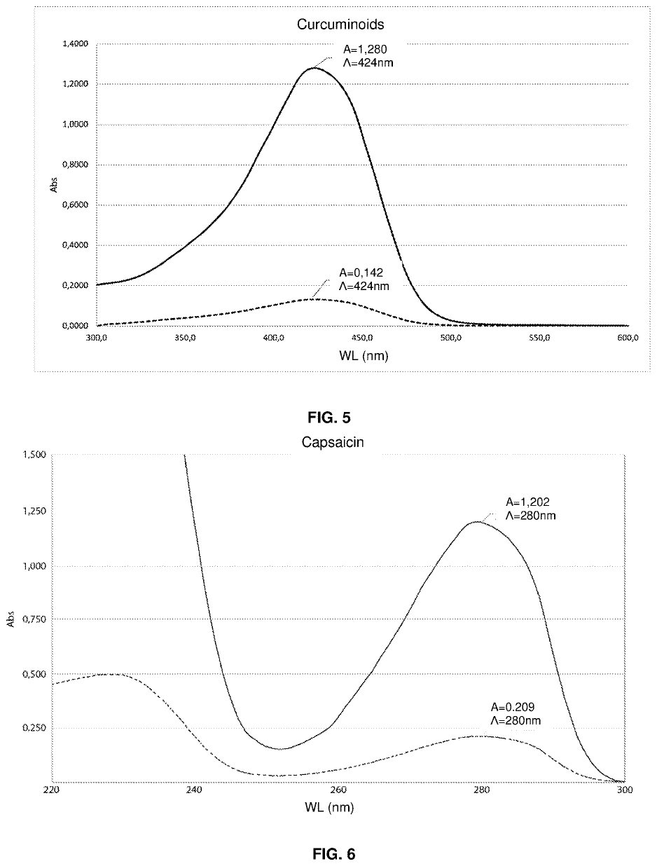

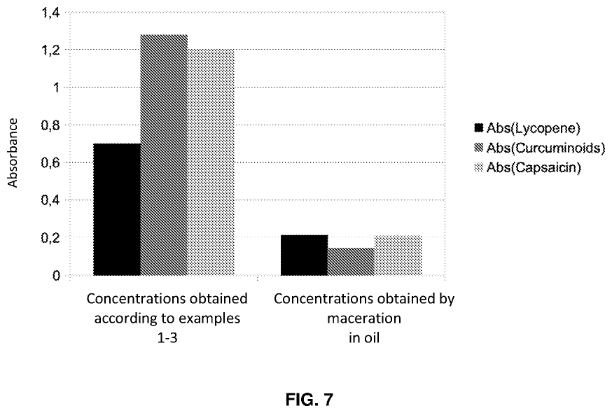

FIG. 5 shows the superimposed UV/VIS spectra of the oils enriched with the two methods in comparison. This analysis also confirms that the sum of the concentrations of the three main curcuminoids present in the oil enriched according to the process of the invention, total concentration proportional to the absorbance measured at 423 nm (A=1.280), is about 9 times higher than the sum of the concentrations of the three main curcuminoids present in the oil enriched using the conventional methodology (A=0.142).

### Capsaicin

FIG. 6 shows the superimposed UV/VIS spectra of sunflower oils enriched with the two methods compared, i.e. by the procedure described in Example 3 and by maceration. Spectrophotometric analysis shows that the concentration of capsaicin present in the oil enriched using the proposed innovative methodology, a concentration proportional to the absorbance measured at 280 nm (A=1.202), is approximately 6 times higher than the concentration of capsaicin present in the oil enriched using the traditional methodology (A=0.209).

The present invention has thus far been described with reference to a preferred embodiment. It is to be understood that there may be other embodiment pertaining to the same inventive core, as defined by the scope of protection of the claims below.

1. Process for the preparation of a composition containing one or more bioactive compounds comprising the following steps:
percolating a halogenated solvent in the liquid phase through a solid material containing at least one bioactive compound under conditions of temperature and corresponding condensation pressure of said halogenated solvent;
collecting the percolated halogenated solvent in an expansion chamber equipped with suction means under conditions of evaporation temperature and corresponding pressure of said halogenated solvent such that the solvent passes into a vapour phase; and
aspirating the halogenated solvent in the vapour phase away from the expansion chamber,
the process being characterised by the fact that said expansion chamber is pre-loaded with a lipid substance such that, when the solvent is aspirated, at least one bioactive compound is released into the lipid substance to give a composition comprising said bioactive compound.

2. Process according to claim 1, further comprising a further step of re-condensing the halogenated solvent aspirated for reuse in one or more further percolation cycles through said solid material, preferably wherein said re-condensation step takes place by means of a heat exchanger.

3. Process according to claim 1 or 2, wherein said halogenated solvent is a halogenated solvent having a condensation pressure at room temperature of about 10 atm or less, preferably wherein said halogenated solvent is chosen from halogenated hydrocarbons, halogenated hydroolefins and mixtures thereof, more preferably wherein said halogenated hydrocarbons are hydrofluorocarbons (HFCs) and said halogenated hydroolefins are hydrofluoroolefins (HFOs), even more preferably wherein the halogenated solvent is chosen from 1,1,1,2-Tetrafluoroethane (R134a) 2,3,3,3-tetrafluoroprop-1-ene (HFO-1234yf) and (1E)-1,3,3,3-tetrafluoroprop-1-ene (HFO-1234ze).

4. Process according to any one of claims 1 to 3, wherein the solid material containing at least one bioactive compound is chosen from: a plant biomass, a concentrated resin oil, a pure bioactive compound or combinations thereof.

5. Process according to any one of claims 1 to 4, wherein the at least one bioactive compound is a lipophilic bioactive compound, preferably of plant origin, more preferably chosen from carotenoids, alkaloids, curcuminoids, cannabinoids and mixtures thereof.

6. Process according to any one of claims 1 to 5, wherein the at least one bioactive compound is chosen from: lycopene, capsaicin, curcumin, CBD, THC and mixtures thereof.

7. Process according to any one of claims 1 to 6, wherein said lipid substance is a lipid substance of vegetable, mineral, synthetic or semi-synthetic origin, preferably an oil, a butter, a wax, more preferably wherein said oil is chosen from sunflower oil, coconut oil, argan oil, wheat germ oil, soybean oil, vaseline oil and mixtures thereof.

8. Food, nutraceutical cosmetic or pharmaceutical product comprising the composition obtainable by the process according to any one of claims 1 to 7 wherein said composition comprises argan oil having a lycopene concentration equal or above 30-35 mg per 100 g composition or wherein said composition comprises wheat germ oil having a curcumin concentration equal or above 1420 mg/per 100 g of composition or wherein said composition comprises sunflower oil having a capsaicin concentration of 61.2 mg per 100 g of composition.

9. Use of a device comprising:
a first pressure-tight chamber 1 configured to house a solid material containing at least one bioactive compound, said chamber being equipped with feed media for a halogenated solvent positioned so that the incoming solvent intercepts the solid material,
said first chamber being in fluid communication with
a second evaporation chamber 3 provided with means for dispensing the solvent 10 from the first chamber 1, suitable for distributing the solvent over an inner surface of the chamber 3 and with suction means for evacuating the solvent in vapour phase, said chamber 3 containing at least one lipid substance
for implementing the process of any one of claims 1 to 7.

10. Use according to claim 9, wherein said second evaporation chamber 3 is connected to a vapor phase halogenated solvent recirculation system comprising compression means 4 and recondensation means 5.

11. Use according to any one of the preceding claims, wherein said feeding means of the solvent to said first chamber comprise a storage tank 6 of said solvent, preferably wherein said means for recondensing the solvent also comprise means for diverting said recondensed solvent to said storage tank.

12. Use according to any one of the preceding claims, wherein said first chamber 1 is provided with a removable basket 2 for containing said solid material, and optionally with heating means arranged near a lower end of said chamber 1.

13. Use according to any one of the preceding claims, wherein the lower portion of said second chamber 3 is provided with a tap 14 for recovering the lipid substance enriched with the at least one bioactive compound.
